(19) United States
(12) Patent Application Publication
(10) Pub. No.: US 2026/0020028 A1
(43) Pub. Date: Jan. 15, 2026

(54) ENHANCING GRANT-FREE UPLINK TRANSMISSION FOR LOW LATENCY TRAFFIC

(71) Applicant: Lenovo (United States) Inc., Morrisville, NC (US)

(72) Inventors: Abir BEN HADJ FREDJ, Frankfurt am Main (DE); Karthikeyan GANESAN, Nauheim (DE); Ali Ramadan ALI, Kraiburg am Inn (DE); Robin Rajan THOMAS, Bad Nauheim (DE)

(21) Appl. No.: 19/327,425

(22) Filed: Sep. 12, 2025

(51) Int. Cl. H04W 72/21; H04L 1/1812; H04L 5/00

(52) U.S. Cl. CPC H04W 72/21; H04L 1/1812; H04L 5/0005

(57) ABSTRACT

Various aspects of the present disclosure relate to enhancements for Type 1 configured grant transmissions. For example, a user equipment (UE) may select or choose a configured grant configuration (CG-config) that dynamically accommodates its uplink data traffic. The UE may indicate the selected CG-config to a network entity using a preamble, such as by transmitting the preamble in advance of or preceding uplink transmissions over selected resources associated with the CG-config (e.g., within a preamble occasion occupying a slot before the uplink transmission). In some cases, the UE may transmit the preamble in a frequency division multiplexing (FDM) manner and/or time division multiplexing (TDM) manner.

### TECHNICAL FIELD

The present disclosure relates to wireless communications, and more specifically to grant-free uplink transmissions, such as by enhancing grant-free uplink transmissions for sporadic low latency traffic.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like)) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-advanced (5G-A), sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems for enhancing grant-free uplink transmissions, such as for sporadic low latency traffic.

A UE for wireless communication is described. The UE may be configured to, capable of, or operable to perform one or more operations as described herein. For example, the UE may comprise at least one memory and at least one processor coupled with the at least one memory and configured to cause the UE to receive a configuration that includes a mapping of a partition of multiple preambles to multiple configured-grant configurations (CG-configs), select a CG-config based on uplink data to be transmitted to a network entity; and transmit a preamble that indicates the selected CG-config to the network entity.

A processor for wireless communication is described. The processor may be configured to, capable of, or operable to perform one or more operations as described herein. For example, the processor may comprise at least one memory and at least one controller coupled with the at least one memory and configured to cause the processor to receive a configuration that includes a mapping of a partition of multiple preambles to multiple CG-configs, select a CG-config based on uplink data to be transmitted to a network entity; and transmit a preamble that indicates the selected CG-config to the network entity.

A method performed or performable by the UE is described. The method may comprise receiving a configuration that includes a mapping of a partition of multiple preambles to multiple CG-configs, selecting a CG-config based on uplink data to be transmitted to a network entity; and transmitting a preamble that indicates the selected CG-config to the network entity.

In some implementations of the UE, processor, and method described herein, the UE, processor, and method may further be configured to, capable of, performed, performable, or operable to transmit the uplink data to the network entity after the transmission of the preamble.

In some implementations of the UE, processor, and method described herein, to transmit the preamble that indicates the selected CG-config, the UE, processor, and method may further be configured to, capable of, performed, performable, or operable to transmit the preamble within a preamble occasion occupying a symbol or a fraction of a symbol.

In some implementations of the UE, processor, and method described herein, the preamble is time-division multiplexed (TDM-ed) or frequency-division multiplexed (FDM-ed) with PUSCH occasions in a slot.

In some implementations of the UE, processor, and method described herein, the preamble is TDM-ed in a symbol or a fraction of a symbol that precedes a physical uplink shared channel (PUSCH) occasion associated with the preamble.

In some implementations of the UE, processor, and method described herein, the preamble is based at least in part on a hash of the uplink data or a sparse compressed-sensing (CS) codebook.

In some implementations of the UE, processor, and method described herein, the preamble includes pilot symbols associated with channel estimation at the network entity.

In some implementations of the UE, processor, and method described herein, the partition of multiple preambles is part of a pool of preambles available to a group of UEs that includes the UE, and wherein the at least one processor is further configured to cause the UE to randomly select a preamble from the pool of preambles.

A network entity for wireless communication is described. The network entity may be configured to, capable of, or operable to perform one or more operations as described herein. For example, the network entity may comprise at least one memory and at least one processor coupled with the at least one memory and configured to cause the network entity to generate a configuration that includes a mapping of one or more preambles transmitted in a preamble partition to one or more CG-configs, wherein each CG-config of the one or more CG-configs includes time-frequency contention-based (CB) or contention free (CF) resources in a time-frequency grid and transmit the generated configuration to a UE.

A method performed or performable by the network entity is described. The method may comprise generating a configuration that includes a mapping of one or more preambles transmitted in a preamble partition to one or more CG-configs, wherein each CG-config of the one or more CG-configs includes time-frequency CB or CF resources in a time-frequency grid and transmit the generated configuration to a UE.

In some implementations of the network entity and method described herein, each preamble of the preamble partition is associated with uplink data to be transmitted via a physical uplink shared channel (PUSCH) over a CG-config of the one or more CG-configs mapped to the preamble.

In some implementations of the network entity and method described herein, each preamble of the preamble partition is TDM-ed or FDM-ed with PUSCH occasions in a slot.

In some implementations of the network entity and method described herein, each preamble of the preamble partition is part of a subset of preambles that identifies one or more collisions between the CB resources in the time-frequency grid.

In some implementations of the network entity and method described herein, each preamble of the preamble partition is selected for the UE.

In some implementations of the network entity and method described herein, the preamble partition is part of a pool of preambles available to a group of UEs that includes the UE.

In some implementations of the network entity and method described herein, the mapping includes an association between a preamble and a CB resource set that is specific to hybrid automatic repeat request (HARQ) retransmissions performed by the UE.

In some implementations of the network entity and method described herein, the network entity and method may further be configured to, capable of, performed, performable, or operable to receive a preamble and uplink data from the UE, identify the UE based on the preamble, and transmit a feedback response message to the UE based on the identification of the UE.

In some implementations of the network entity and method described herein, the feedback response message includes a field that indicates a successful reception of the uplink data over a CB uplink resource or a configuration of an uplink grant for the uplink data retransmission over the CB uplink resource.

### BRIEF DESCRIPTION OF THE DRAWINGS

FIG. 1 illustrates an example of a wireless communications system in accordance with aspects of the present disclosure.

FIG. 2 illustrates an example mapping of preambles to configured grant configurations in accordance with aspects of the present disclosure.

FIG. 3 illustrates an example multiplexing of preamble occasions to PUSCH occasions in accordance with aspects of the present disclosure.

FIG. 4 illustrates an example preamble generation in accordance with aspects of the present disclosure.

FIG. 5 illustrates an example preamble design in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a NE in accordance with aspects of the present disclosure.

FIG. 9 illustrates a flowchart of a method performed by a UE in accordance with aspects of the present disclosure.

FIG. 10 illustrates a flowchart of a method performed by an NE in accordance with aspects of the present disclosure.

### DETAILED DESCRIPTION

In a wireless communications system, a configured grant is transmitted by an NE to allocate (or pre-allocate) network resources to one or more UEs. In wireless communications systems supporting 5G technology, the UEs and NEs may support two types of configured grants, a Type 1 and a Type 2 configured grant. In Type 1, an NE (e.g., a gNodeB, or gNB) provides a configured uplink grant, having a periodicity with a semi-static resource allocation, via radio resource control (RRC) signaling. UEs may be assigned resources for uplink transmissions upon receiving uplink data (e.g., within buffers of the UEs). For example, the gNB may assign the resources in a one-to-one mapping between a UE and a resource (e.g., in a semi-persistent scheduling (SPS) mechanism) or in a many-to-one mapping (e.g., where uplink transmissions are subject to contention due to collisions resulting from multiple UEs using the same time and frequency resources).

In Type 2, the RRC defines a periodicity of the configured uplink grant, and a physical downlink control channel (PDCCH), addressed to a configured scheduling (CS)-radio network temporary identifier (RNTI), signals and activates/deactivates the configured uplink grant, to provide semi-persistent uplink-shared channel (UL-SCH) resources to the UEs. Both Type 1 and Type 2 configured grants may be configured by the RRC signaling per bandwidth partition (BWP) of a serving cell and multiple configured grants may be active simultaneously for a BWP.

In some cases, the NE (e.g., a gNB) utilizes a scheduler to assign resources for uplink grant-free transmissions. Such assignments may cause spectral inefficiencies, such as when data traffic from the UEs is bursty and/or sporadic. To resolve such issues, the present disclosure introduces technology that enhances the use of the Type 1 configured grant.

For example, a UE may select or choose a configured grant configuration (CG-config) that dynamically accommodates its uplink data traffic. The UE may indicate the selected CG-config to the NE (e.g., the gNB) using a preamble, such as by transmitting the preamble in advance of or preceding uplink transmissions over the selected resources associated with the CG-config (e.g., within a preamble occasion occupying a slot before the uplink transmission). The UE may transmit the preamble in a frequency division multiplexing (FDM) manner and/or time division multiplexing (TDM) manner.

Thus, in accordance with one or more aspects of the present disclosure, the wireless communications system may facilitate a UE to dynamically select and utilize a configured grant upon the arrival of uplink data to be transmitted to the NE. In doing so, the wireless communications system may improve spectral efficiencies associated with allocating resources to UEs for uplink transmissions, such as for low latency or sporadic data traffic transmissions, among other benefits.

Aspects of the present disclosure are described in the context of a wireless communications system.

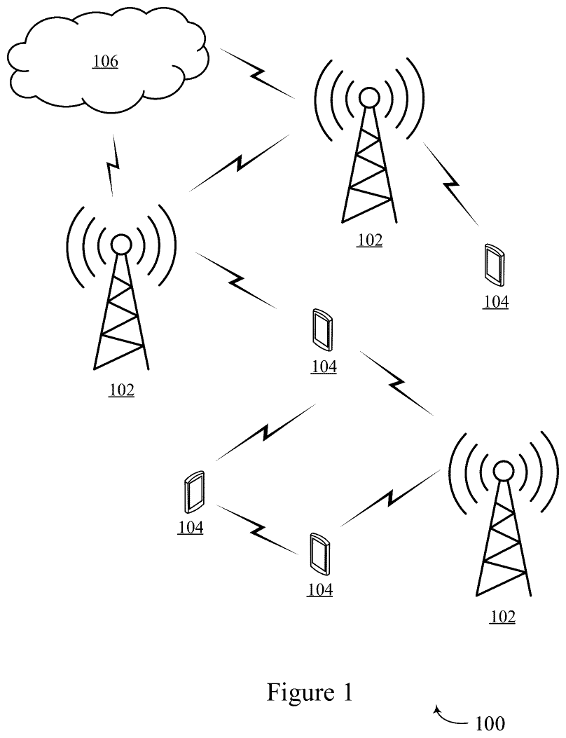

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be an NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more NE 102 associated with the CN 106.

The CN 106 may communicate with a packet data network over one or more backhaul links (e.g., via an S1, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHZ-24.25 GHz), FR4 (52.6 GHz-114.25 GHZ), FR4a or FR4-1 (52.6 GHz-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, the wireless communications system 100 may facilitate the configuration of UEs (e.g., the UE 104) to perform grant-free uplink data transmissions using preambles. For example, the NE 102 (e.g., a gNB) may configure the UE 104 with a preamble (or a set, pool, or partition of preambles) that is associated with uplink data transmitted over one or more CG-configs mapped to the preamble and via a PUSCH resource.

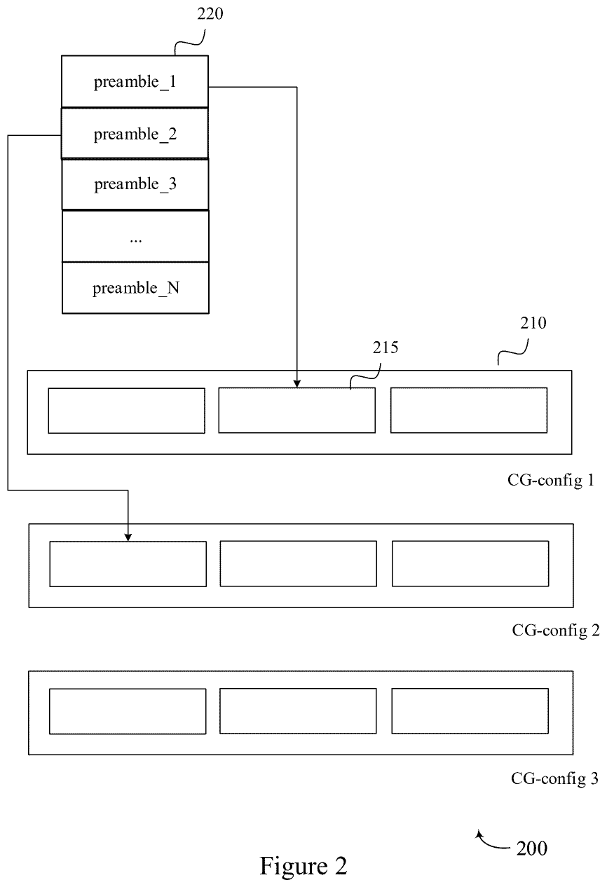

FIG. 2 illustrates an example mapping 200 of preambles to configured grant configurations in accordance with aspects of the present disclosure. For example, the mapping 200 may include a partition of multiple preambles 220 (e.g., preamble_1, preamble_2, preamble_3 . . . preamble_N) to multiple CG-configs 210 (e.g., CG-config 1, CG-config 2, CG-config 3, and so on).

Each preamble (e.g., preamble_1) may be associated with and/or represent a time-frequency resource 215, or preamble occasion, for an associated CG-config 210. For example, FIG. 2 depicts the preamble “preamble_1” as being mapped to or otherwise associated with a time-frequency resource in “CG-config 1” and depicts the preamble “preamble_2” as being mapped to or otherwise associated with a time-frequency resource in “CG-config 2.” In some cases, one or more preambles of the partition of multiple preambles 220 are specific to the UE 104.

The CG-configs may indicate, to the UE 104, one or more uplink resource configurations associated with various parameters, including:

CG-Preamble; cs-RNTI: CS-RNTI for retransmission; cg-SDT-CS-RNTI: CS-RNTI for CG-SDT retransmission; cg-SDT-RSRP-ThresholdSSB: a reference signal received power (RSRP) threshold configured for synchronization signal and physical broadcast channel block (e.g., a synchronization signal block (SSB)) selection for configured grant small data transmission (CG-SDT); cg-RRC-RSRP-ThresholdSSB: an RSRP threshold configured for SSB selection for random access channel (RACH)-less handover; periodicity: periodicity of a configured grant Type 1; timeDomainOffset: an offset of a resource with respect to a system frame number (SFN)=time ReferenceSFN in time domain; timeDomainAllocation: an allocation of a configured uplink grant in time domain that contains startSymbolAndLength or startSymbol; nrofHARQ-Processes: the number of hybrid automatic repeat request (HARQ) processes for configured grant; harq-ProcID-Offset: an offset of HARQ process for configured grant configured with cg-RetransmissionTimer for operation with shared spectrum channel access; harq-ProcID-Offset2: an offset of HARQ process for configured grant not configured with cg-RetransmissionTimer; time ReferenceSFN: SFN used to determine the offset of a resource in time domain, where the UE 104 may use the closest SFN with the indicated number preceding the reception of the configured grant configuration; timeReference HyperSFN: H-SFN used for determination of the offset of a resource in time domain, where the UE 104 may use the closest H-SFN with the indicated number preceding the reception of the configured grant configuration; and so on.

In some cases, a one-to-one PUSCH mapping may be configured for each UE for CF transmissions and/or a many-to-one mapping may be configured for a group of UEs, such that multiple different UEs may transmit uplink data (e.g., CB transmissions) over the same time-frequency resources using the same preamble.

In some examples, a UE-specific preamble may be configured and transmitted within a preamble occasion or resource and may be FDM-ed and/or TDM-ed with an associated CB-PUSCH resource or CF-PUSCH resource (e.g., the time-frequency resources 215) that corresponds to one or more CG-configs 210 for the preamble. With respect to TDM, the UE 104 may transmit a preamble within a symbol (or samples or parts of the symbol) that precedes the CB-PUSCH/CF-PUSCH slots.

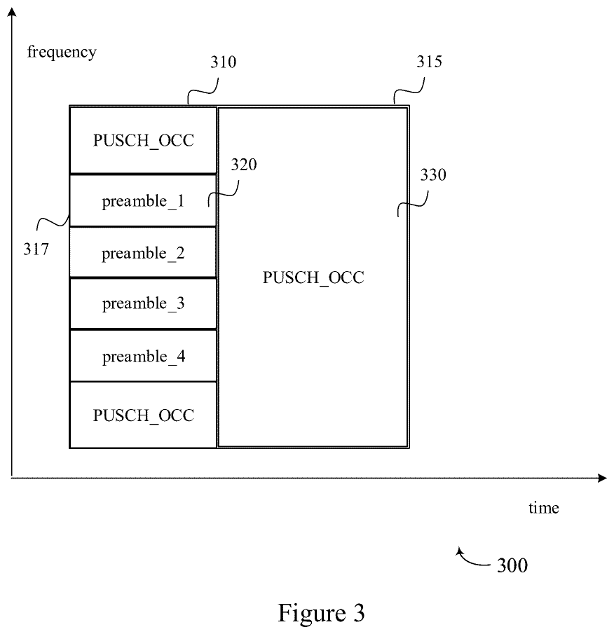

In some cases, the preamble may be both TDM-ed and FDM-ed with the CB-PUSCH/CF-PUSCH slots and associated subcarriers. FIG. 3 illustrates an example multiplexing 300 of preamble occasions to PUSCH occasions in accordance with aspects of the present disclosure. As shown, preambles 320 may be positioned within a symbol 310 that precedes a symbol 315 for a PUSCH occasion (e.g., PUSCH_OCC) in the time domain and/or is FDM-ed with PUSCH occasions in subcarriers 317 in the frequency domain.

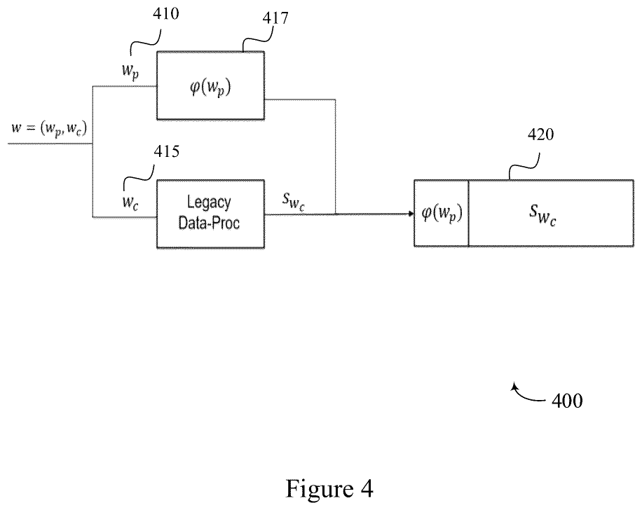

In some examples, the UE 104 may generate a preamble (e.g., a UE-specific preamble) by cyclically shifting a Zadoff-chu root sequence or a pseudo random sequence, such as a Golay or Gold sequence. The UE 104 may generate the preamble based on uplink data received or buffered by the UE 104. FIG. 4 illustrates an example preamble generation 400 in accordance with aspects of the present disclosure.

For example, the UE data u may be divided into two parts (u₁, u₂), where the first part is used as a preamble (e.g., a Hash function is performed over the u₁ to generate P₁). The Hash function may be associated with one or more CG-configs, one or more modulation and coding schemes (MCSs), and/or one or more transport block (TB) sizes.

FIG. 4 illustrates an example preamble generation 400 in accordance with aspects of the present disclosure. UE data (e.g., uplink data, or w) is split into two parts, where a first part 410 is hashed or encoded 417 using a sparse codebook (as described herein) and serves to identify a second part 415 of the actual data in an uplink transmission 420.

In some cases, the preamble may not facilitate identification of the UE 104; instead, a UE identifier may be embedded within the uplink data associated with and/or transmitted by the UE 104. The uplink data from multiple UEs may be code division multiplexed (CDM-ed) within one or more CB-PUSCH/CF-PUSCH occasions using orthogonal spreading/cover sequences (e.g., orthogonal cover code (OCC)). In such cases, the preamble or Hash function may identify the spreading/cover sequence associated with a UE, which may enable a de-spreading procedure at a gNB receiving the transmissions.

In some examples, multiple UEs may be configured to autonomously select a preamble from a set or pool of pre-defined/pre-configured preambles (Cp). The two or more UEs may select the same preamble from a preamble pool that is limited due to a maximum number of orthogonal sequences (or sequences with a low inner product). In such a scenario, two (or more) different UEs may transmit uplink PUSCH data using the same CG-config resources, resulting in a collision of resources.

In some cases, the gNB may initiate a contention resolution for the UEs. For example, the gNB may detect the uplink data from one of the UEs (e.g., UE 2), and, having knowledge of the identities of the UEs, acknowledge reception of the uplink data of the other UE (e.g., UE 1) via a HARQ ACK or downlink control information (DCI) scrambled with an identifier for the UE. In some cases, the gNB may not detect uplink from any of the UEs and initiates a contention resolution procedure for the UEs. The gNB may allocate uplink resources of configured grants to both UEs (e.g., the UE 1 and the UE 2) for an initial HARQ transmission and HARQ retransmissions according to a Type 1 configured grant. In response, the UE 1 may use a CG-config indicated by the gNB for HARQ and the UE 2 may use a different CG-config as indicated by the gNB via RRC signaling.

In some examples, such as when collisions occur during or for contention-based PUSCH transmissions, the UE 104 may be identified by specific pilot bits, such as bits that implicitly carry the identity of the UE 104 (e.g., demodulation reference signals (DMRSs) scrambled by a UE identifier (e.g., an RNTI) or any UE-specific scrambling sequence). The gNB may request the UE 104 to retransmit a lost packet. The UE 104 may be assigned with a UE-specific preamble for retransmissions, as described, such as when an associated service has stringent latency requirements. In some cases, the UE 104 may use the same preamble that was used for a first transmission and only indicate the mapping to a CG-config dedicated or associated with retransmissions. For example, “CG-config 3” depicted in FIG. 2, may only be associated and/or used for retransmissions of uplink data by the UE 104.

In some examples, such as to further enhance the transmission capacity during heavy transmission load scenarios, the preamble may map to an OCC sequence used by the UE 104 to spread its U-SCH data, and multiple UEs may be multiplexed on the same time-frequency resources. For example, the preamble may indicate both the CG-config and the OCC sequence. The gNB may utilize the OCC sequence de-spread the UE data within the time-frequency resources represented by and/or identified by the preamble configuration.

In some examples, a preamble or preambles within a partition of multiple preambles, may be designed and/or structured to accommodate UE preamble superposition over a same preamble occasion (e.g., time-frequency resources). The preambles may be based on a sparse linear codebook shared between all UEs and/or based on a hash function performed over a UE part of the data and used to decode the PUSCH data associated with that specific UE. Additionally, the gNB may utilize the preamble for channel estimation, which may reduce the signaling overhead related to pilot symbols (such as DMRS).

In some cases, the preambles of different UEs may be superposed and randomly transmitted within the preamble occasions. The gNB, instead of detecting and decoding each of the preambles, detects and decodes a sum of codewords (e.g., generated based on a compressed sensing (CS) codebook). The detection may be performed using knowledge about the Hash function used by each UE or by using compressed sensing decoders (e.g., an approximate message passing algorithm (AMP)).

For example, given three UEs, each UE has a preamble (p₁, p₂, p₃). As described herein, the preambles may be based on or generated from parts of each UE data (wₚ_{₁}, wₚ_{₂}, wₚ_{₃}) using either a Hash function φ or a sparse CS codebook C_{S}. Further, the channels of all potential users are assumed frequency flat and static within a transmission duration, where each channel suffers additive white gaussian noise (AWGN), denoted as nᵢ, with zero mean and variance of σ².

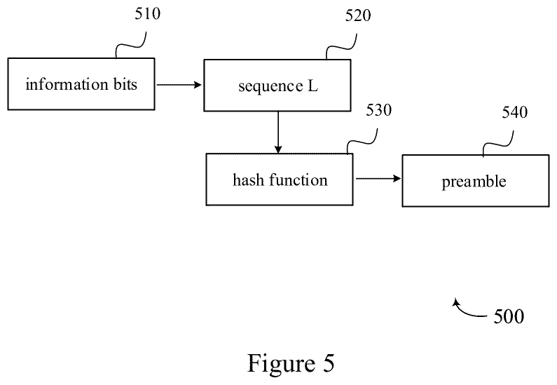

FIG. 5 illustrates an example preamble design 500 in accordance with aspects of the present disclosure. The UE 104 (e.g., a transmitter of a preamble) extracts several information bits 510 from a packet, and forms a sequence 520 (e.g., of length L), which may be decimally indexed. The UE 104 hashes the sequence 520 using a Hash function 530 to generate a preamble 540. In some case, the UE 104 may encode the sequence 520 using a shared CS codebook between different users.

Each preamble may be associated with a preamble index i, which may be associated with an interleaving and repetition pattern performed over the uplink data of each UE. A gNB may then receive a signal, as follows:

$$y = {p}_{1} + {p}_{2} + {p}_{3} + n$$

The gNB, acting as a receiver, detects the preamble and identifies UL-SCH data resources and the interleaving and repetition patterns used to differentiate the uplink data for each UE (e.g., for CB uplink transmissions). Thus, the superposition of multiple UEs over the same resources in a grant-free manner may be performed, resulting in higher capacity and low-latency transmissions with respect to an additional computational overhead at the gNB when implementing advanced multi-user detection algorithms (e.g., such as successive interference cancellation (SIC), treat interference as noise (TIN)-SIC, and so on.

In some cases, the gNB (or other NE 102) may include an advanced TIN-SIC receiver, such as when a CS codebook is used to generate preambles, may be a sparse block interleaver division multiple access (SB-IDMA) receiver architecture. For example, using the SB-IDMA receiver, the gNB may, for each detected preamble, determine a sequence of preamble occasions used to transmit user segments as well as a sequence of pilot fields and perform channel estimation and interference-plus-noise power estimation for each preamble occasion. For correctly decoded messages, the gNB performs SIC, where a channel coefficient is re-estimated, for each segment, using the decoded data as an extended pilot field. The gNB may then remove any interference contribution of each segment from a respective preamble occasion and cancel the interference contribution of the corresponding preamble from the PRACH observation, with a channel coefficient provided by an orthogonal matching pursuit (OMP) algorithm.

In some cases, the gNB may detect a list of codewords (e.g., instead of detecting each UE, and utilize a mapping of a preamble to a CG-config to an OCC/spreading sequence to decode and/or detect the identifier of the UE and the uplink data.

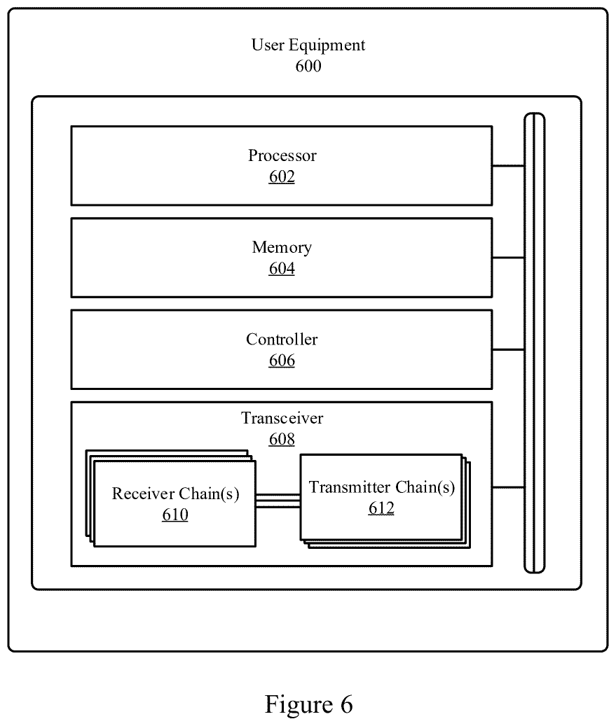

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to support a means for receiving a configuration that includes a mapping of a partition of multiple preambles to CG-configs, selecting a CG-config based on uplink data to be transmitted to a network entity, and transmitting a preamble that indicates the selected CG-config to the network entity.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

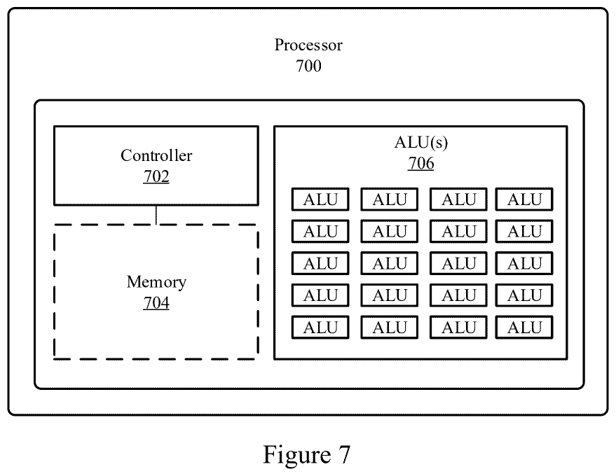

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The UE processor 700 may be configured to support a means for receiving a configuration that includes a mapping of a partition of multiple preambles to CG-configs, selecting a CG-config based on uplink data to be transmitted to a network entity, and transmitting a preamble that indicates the selected CG-config to the network entity.

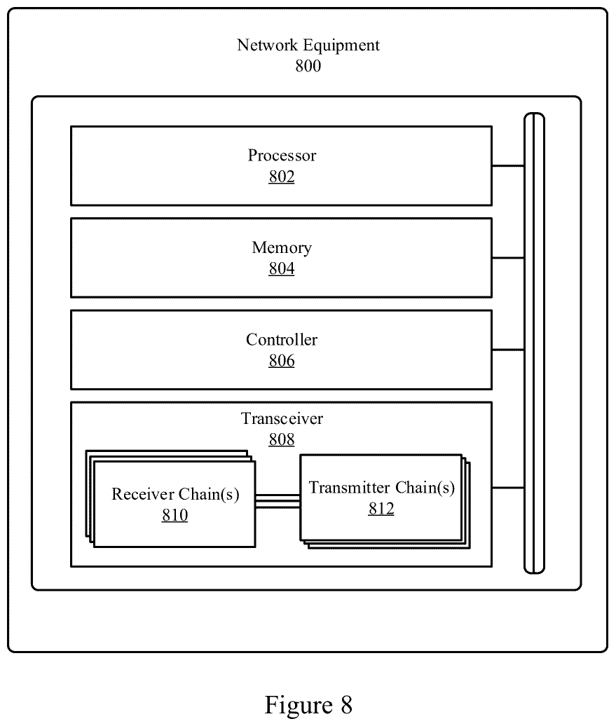

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to support a means for generating a configuration that includes a mapping of one or more preambles transmitted in a preamble partition to one or more CG-configs, wherein each CG-config of the one or more CG-configs includes time-frequency CB or CF resources in a time-frequency grid and transmitting the generated configuration to a UE.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

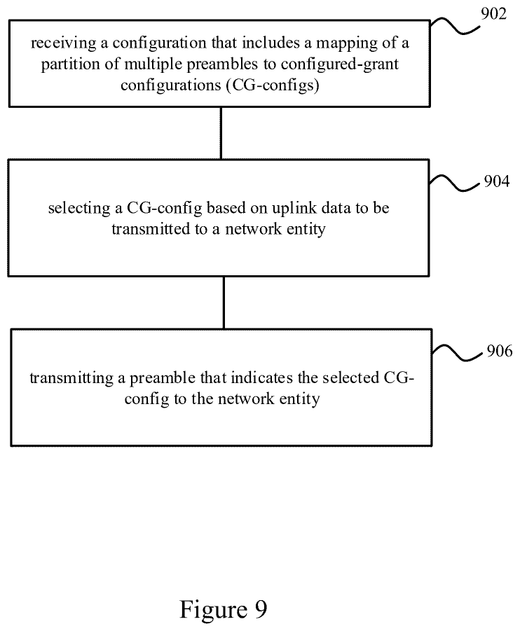

FIG. 9 illustrates a flowchart of a method in accordance with aspects of the present disclosure. The operations of the method may be implemented by a UE as described herein. In some implementations, the UE may execute a set of instructions to control the function elements of the UE to perform the described functions.

At 902, the method may include receiving a configuration that includes a mapping of a partition of multiple preambles to CG-configs. The operations of 902 may be performed in accordance with examples as described herein. In some implementations, aspects of the operations of 902 may be performed by a UE as described with reference to FIG. 6.

At 904, the method may include selecting a CG-config based on uplink data to be transmitted to a network entity. The operations of 904 may be performed in accordance with examples as described herein. In some implementations, aspects of the operations of 904 may be performed by a UE as described with reference to FIG. 6.

At 906, the method may include transmitting a preamble that indicates the selected CG-config to the network entity. The operations of 906 may be performed in accordance with examples as described herein. In some implementations, aspects of the operations of 906 may be performed by a UE as described with reference to FIG. 6.

It should be noted that the method described herein describes a possible implementation, and that the operations and the steps may be rearranged or otherwise modified and that other implementations are possible.

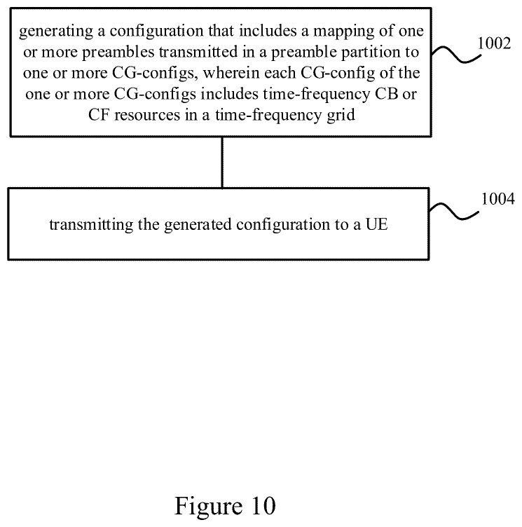

FIG. 10 illustrates a flowchart of a method in accordance with aspects of the present disclosure. The operations of the method may be implemented by an NE as described herein. In some implementations, the reader device may execute a set of instructions to control the function elements of the reader device to perform the described functions.

At 1002, the method may include generating a configuration that includes a mapping of one or more preambles transmitted in a preamble partition to one or more CG-configs, wherein each CG-config of the one or more CG-configs includes time-frequency CB or CF resources in a time-frequency grid. The operations of 1002 may be performed in accordance with examples as described herein. In some implementations, aspects of the operations of 1002 may be performed by an NE as described with reference to FIG. 8.

At 1004, the method may include transmitting the generated configuration to a UE. The operations of 1004 may be performed in accordance with examples as described herein. In some implementations, aspects of the operations of 1004 may be performed by an NE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
at least one memory; and
at least one processor coupled with the at least one memory and configured to cause the network entity to:
generate a configuration that includes a mapping of one or more preambles transmitted in a preamble partition to one or more configured-grant configurations (CG-configs),
wherein each CG-config of the one or more CG-configs includes time-frequency contention-based (CB) or contention free (CF) resources in a time-frequency grid; and
transmit the generated configuration to a user equipment (UE).

2. The network entity of claim 1, wherein each preamble of the preamble partition is associated with uplink data to be transmitted via a physical uplink shared channel (PUSCH) over a CG-config of the one or more CG-configs mapped to the preamble.

3. The network entity of claim 2, wherein each preamble of the preamble partition is time-division multiplexed (TDM-ed) or frequency-division multiplexed (FDM-ed) with PUSCH occasions in a slot.

4. The network entity of claim 1, wherein each preamble of the preamble partition is part of a subset of preambles that identifies one or more collisions between the CB resources in the time-frequency grid.

5. The network entity of claim 1, wherein each preamble of the preamble partition is selected for the UE.

6. The network entity of claim 1, wherein the preamble partition is part of a pool of preambles available to a group of UEs that includes the UE.

7. The network entity of claim 1, wherein the mapping includes an association between a preamble and a CB resource set that is specific to hybrid automatic repeat request (HARQ) retransmissions performed by the UE.

8. The network entity of claim 1, wherein the at least one processor is further configured to cause the network entity to:
receive a preamble and uplink data from the UE;
identify the UE based on the preamble; and
transmit a feedback response message to the UE based on the identification of the UE.

9. The network entity of claim 8, wherein the feedback response message includes a field that indicates:
a successful reception of the uplink data over a CB uplink resource; or
a configuration of an uplink grant for the uplink data retransmission over the CB uplink resource.

10. A user equipment (UE) for wireless communication, comprising:
at least one memory; and
at least one processor coupled with the at least one memory and configured to cause the UE to:
receive a configuration that includes a mapping of a partition of multiple preambles to multiple configured-grant configurations (CG-configs);
select a CG-config based on uplink data to be transmitted to a network entity; and
transmit a preamble that indicates the selected CG-config to the network entity.

11. The UE of claim 10, wherein the at least one processor is further configured to cause the UE to:
transmit the uplink data to the network entity after the transmission of the preamble.

12. The UE of claim 10, wherein, to transmit the preamble that indicates the selected CG-config, the at least one processor is configured to cause the UE to transmit the preamble within a preamble occasion occupying a symbol or a fraction of a symbol.

13. The UE of claim 10, wherein the preamble is time-division multiplexed (TDM-ed) or frequency-division multiplexed (FDM-ed) with PUSCH occasions in a slot.

14. The UE of claim 13, wherein the preamble is TDM-ed in a symbol or a fraction of a symbol that precedes a physical uplink shared channel (PUSCH) occasion associated with the preamble.

15. The UE of claim 10, wherein the preamble is based at least in part on a hash of the uplink data or a sparse compressed-sensing (CS) codebook.

16. The UE of claim 10, wherein the preamble includes pilot symbols associated with channel estimation at the network entity.

17. The UE of claim 10, wherein the partition of multiple preambles is part of a pool of preambles available to a group of UEs that includes the UE, and wherein the at least one processor is further configured to cause the UE to randomly select a preamble from the pool of preambles.

18. A method performed by a network entity, the method comprising:
generating a configuration that includes a mapping of one or more preambles transmitted in a preamble partition to one or more configured-grant configurations (CG-configs),
wherein each CG-config of the one or more CG-configs includes time-frequency contention-based (CB) or contention free (CF) resources in a time-frequency grid; and
transmitting the generated configuration to a user equipment (UE).

19. The method of claim 18, wherein each preamble of the preamble partition is associated with uplink data to be transmitted via a physical uplink shared channel (PUSCH) over a CG-config of the CG-configs mapped to the preamble.

20. A method performed by a user equipment (UE), the method comprising:
receiving a configuration that includes a mapping of a partition of multiple preambles to configured-grant configurations (CG-configs);
selecting a CG-config based on uplink data to be transmitted to a network entity; and
transmitting a preamble that indicates the selected CG-config to the network entity.
